(19) United States
(12) Patent Application Publication
(10) Pub. No.: US 2014/0212659 A1
(43) Pub. Date: Jul. 31, 2014

(54) Antistatic Protective Film, Display Device, And Preparation Method Of Antistatic Protective Film

(71) Applicant: BOE Technology Group Co., Ltd., Beijing (CN)

(72) Inventors: Tianming Dai, Beijing (CN); Jianshe Xue, Beijing (CN)

(73) Assignee: BOE Technology Group Co., Ltd., Beijing (CN)

(21) Appl. No.: 13/995,463

(22) PCT Filed: Sep. 24, 2012
(86) PCT No.: PCT/CN2012/081853

§ 371 Date: Jun. 18, 2013

(30) Foreign Application Priority Data
Feb. 13, 2012 (CN) 201210031741.7

(51) Int. Cl. H01B 1/04; B32B 9/04

(52) U.S. Cl. CPC H01B 1/04; B32B 9/045
USPC 428/336; 428/408; 428/337; 216/36; 427/600; 252/511

(57) ABSTRACT

Embodiments of the present invention provide an antistatic protective film, a display device, and a preparation method of an antistatic protective film. The antistatic protective film comprises: a layer of substrate and a layer of graphene; the substrate and the graphene layer are adhered together. The antistatic protective film in accordance with the embodiment of the present invention, utilizes graphene to protect a component from being scratched by a foreign object or damaged by rubbing, and at the same time allows static electricity on an electronic component to be discharged in time, thus avoids the electronic component from being damaged by static electricity and prolongs the service life of the electronic component; meanwhile, the antistatic protective film has high light-transmittance, which greatly reduces the influence of the antistatic protective film on the output light of the electronic component.

### TECHNICAL FIELD

Embodiments of the present invention relate to an antistatic protective film, a display device, and a preparation method of an antistatic protective film.

### BACKGROUND

Nowadays, electronic components such as mobile-phone screens, liquid-crystal-display panels, and the like have precise structures and thus expensive at price; in order to prevent the electronic components from being scratched or being subjected to other damages during transportation and in use, usually a layer of antistatic protective film is adhered to the surfaces of the electronic components. The antistatic protective film is used both for safety of the electronic components, but also for prevention of static-electricity damages to the electronic component.

Such antistatic protective film used for protecting electronic components is principally a polymer thin film, inside of which is filled with antistatic agent, including a thin film of polymer such as polyethylene terephthalate or the like. A thin film of polymer such as polyethylene terephthalate or the like has relatively high resistivity in its surface, which leads to an unstable effect of antistatic protection; in addition, the thin film has insufficient flexibility, which causes the electronic components likely to be damaged by scratches and thus leads to low safety.

### SUMMARY

Embodiments of the present invention provides an antistatic protective film, a display device, and a preparation method of an antistatic protective film for solving problems of high resistivity and low safety of an antistatic protective film in prior art.

An embodiment of the present invention provides an antistatic protective film, comprising: a layer of substrate and a layer of graphene; the substrate and the graphene layer are adhered together.

For example, the graphene layer has a thickness in a range of 20-200 nm.

For example, the material of the substrate comprises one of the substances as follows: polyethylene, polypropylene, polycarbonate, polyvinyl chloride, polyimide, epoxy resin, phenolic resin, polyethylene terephthalate (PET) and rubber.

For example, the substrate has a thickness in a range of 50-1000 nm.

Another embodiment of the present invention further provides a display device, comprising an antistatic protective film of any type as described above.

Yet another embodiment of the present invention further provides a method of preparing an antistatic protective film, comprising:

cleaning a substrate; and

preparing a layer of graphene on the substrate.

The step of preparing a layer of graphene on the substrate, comprises:

placing a metal sheet in a chamber containing a carbonaceous gas;

pyrolyzing the carbonaceous gas at a preset temperature so that the layer of graphene is deposited on the metal sheet;

adhering the metal sheet and the affixed graphene onto the substrate, in which the graphene is adhered in contact with the substrate; and

removing the metal sheet by etching so that an antistatic protective film is obtained.

For example, the preset temperature is in a range of 600-1000° C.

The carbonaceous gas comprises a gas of at least one of the substances as follows: carbon monoxide, ethane, ethylene, ethanol, acetylene, propane, butadiene, cyclopentadiene, benzene and toluene.

For example, the step of removing the metal sheet by etching, comprises:

removing the metal by etching with an acidic solution; and

the acidic solution comprises hydrochloric acid, sulfuric acid or acetic acid.

For example, the step of preparing a layer of graphene on the substrate, comprises:

coating graphene oxide powders on a surface of the substrate; and

reducing the graphene oxide powders to graphene by a reductant;

the reductant comprises hydrazine, hydrazine hydrate, sodium borohydride or halogen acid.

For example, the step of coating graphene oxide powder on a surface of the substrate, comprises:

dissolving the graphene oxide powder in water, the graphene oxide-aqueous solution having a concentration of 0.1˜10 mg/ml; and

subjecting the graphene oxide-aqueous solution to ultrasonic treatment.

The present invention has beneficial effects as follows.

In the embodiment of the present invention, the antistatic protective film comprises graphene; the antistatic protective film utilizes graphene to protect an electronic component from being scratched by a foreign object or damaged by rubbing, and at the same time allows static electricity on the electronic component to be discharged in time, thus avoids the electronic component from being damaged by static electricity and prolongs the service life of the electronic component; meanwhile, the antistatic protective film has high light-transmittance, which greatly reduces the influence of the antistatic protective film on the output light of the electronic component.

### BRIEF DESCRIPTION OF THE DRAWINGS

In order to clearly illustrate the technical solutions of the embodiments of the invention, the drawings of the embodiments will be briefly described in the following; it is obvious that the described drawings are only related to some embodiments of the invention and thus are not limitative of the invention.

FIG. 1 is a schematic structural view of an embodiment of an antistatic protective film according to the present invention;

FIG. 2 is a flowchart illustrating a first embodiment of a preparation method of an antistatic protective film according to the present invention;

FIG. 3 is a flowchart illustrating a second embodiment of a preparation method of an antistatic protective film according to the present invention;

FIG. 4 is a schematic diagram illustrating a roll-to-roll adhesion manner in the embodiment; and

FIG. 5 is a schematic diagram illustrating a roll-to-roll transfer-printing mode in the embodiment.

### DETAILED DESCRIPTION OF THE PREFERRED EMBODIMENTS

In order to make objects, technical details and advantages of the embodiments of the invention apparent, the technical solutions of the embodiments will be described in a clearly and fully understandable way in connection with the drawings related to the embodiments of the invention. It is obvious that the described embodiments are just a part but not all of the embodiments of the invention. Based on the described embodiments herein, those skilled in the art can obtain other embodiment(s), without any inventive work, which should be within the scope of the invention.

FIG. 1 is a schematic structural view of an embodiment of an antistatic protective film according to the present invention. As shown in FIG. 1, the antistatic protective film of this embodiment comprises a transparent substrate 101 and a layer of graphene layer 102; the substrate 101 and the graphene layer 102 are tightly adhered together. The graphene layer 102 at ambient conditions of room temperature has excellent electrical properties with its intrinsic electron mobility up to 200000 cm²/V*s; the graphene layer 102 has a transmittance as high as. 97.7% with respect to the visible light; in the graphene layer 102, each carbon atom forms three σ-bonds with three neighboring carbon atoms, and therefore the graphene layer 102 has extreme hardness and very good wear-resistance, which is helpful to prepare a protective film.

For example, the graphene layer 102 may have a thickness in a range of 20-200 nm, which ensures that the graphene layer 102 not only has the performances such as extreme hardness and good wear-resistance but also will not affect its light-transmittance. For example, when the graphene layer 102 has a thickness of 100 nm, a force of 200 kN is needed to tear it up.

For example, the conductive substrate 101 has a thickness in a range of 50-1000 nm, and the exemplary material of the substrate 101 comprises: polyethylene, polypropylene, polycarbonate, polyvinyl chloride, polyimide, epoxy resin, phenolic resin, rubber, or the like. Depending on its applicable objects, the substrate also may be non-transparent.

In this embodiment, the antistatic protective film comprises graphene; the antistatic protective film utilizes graphene to protect an electronic component from being scratched by a foreign object or damaged by rubbing, and at the same time allows static electricity on the electronic component to be discharged in time, thus avoids the electronic component from being damaged by static electricity and prolongs the service life of the electronic component; meanwhile, the antistatic protective film has high light-transmittance, which greatly reduces the influence of the antistatic protective film on the output light of the electronic component.

Another embodiment of the present invention further provides a display device; the display device has a layer of antistatic protective film as shown in FIG. 1 affixed onto an electronic component thereof, so that the antistatic protective film provides the display device double protection, that is, not only protects the display device from damages such as scratches or scuffs but also provides the display device with antistatic protection. For example, the display device may be a liquid crystal display, a mobile phone, a camera, etc., with the above-described antistatic protective film adhered onto the display panel of the liquid crystal display or the mobile phone, or onto the lens of the camera, so that the display device obtains double protection.

Yet another embodiment of the present invention further provides a preparation method of an antistatic protective film; in practice, a chemical vapor deposition (CVD) method or a reduction method may be utilized to prepare a layer of graphene 102 on the substrate 101.

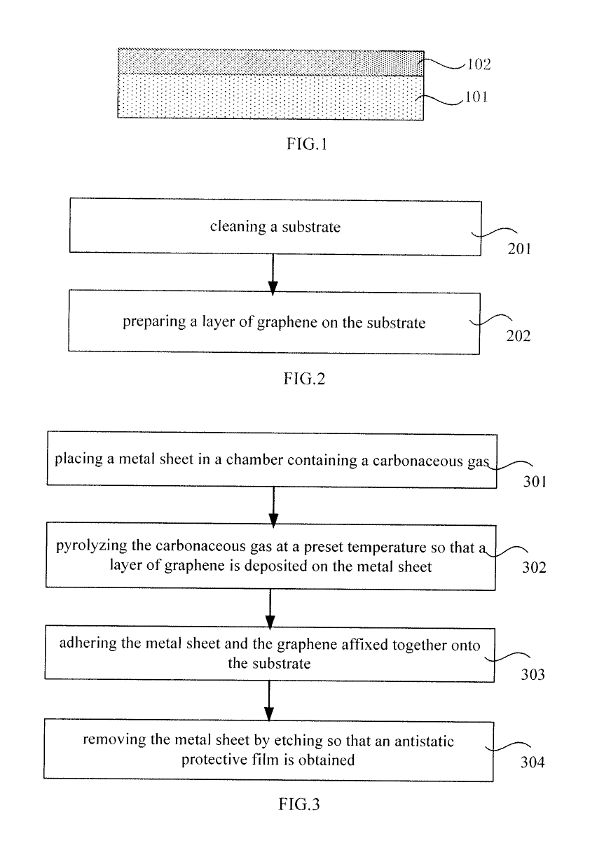

In this embodiment, the technical scheme will be introduced by an example in which a reduction method is utilized to prepare the graphene layer 102 on the substrate 101. FIG. 2 is a flowchart illustrating a first embodiment of a preparation method of an antistatic protective film according to the present invention. As shown in FIG. 2, in this embodiment, a specific procedure of the method of preparing an antistatic protective film comprises steps as follows:

Step 201, cleaning a substrate.

In this step, the substrate 101 is firstly cleaned with deionized water or any other cleaning liquid, then the substrate 101 is subjected to drying treatment; thereafter, the procedure proceeds to step 202.

Step 202, preparing a layer of graphene on the substrate so that an antistatic protective film is obtained.

At this step, firstly, graphene oxide powders are dissolved in water, and the graphene oxide-aqueous solution has a concentration of 0.1˜10 mg/ml. The above graphene oxide-aqueous solution may be subjected to ultrasonic treatment, so that the graphene oxide powders are fully dissolved in the water. Then, the substrate 101 is placed in the aqueous solution, so that the graphene oxide powder uniformly adders onto the substrate 101. Next, the substrate 101 coated with the graphene oxide powder is dried. Finally, the graphene oxide is reduced by a reductant such as hydrazine, hydrazine hydrate, sodium borohydride or halogen acid, so that a layer of graphene 102 having a uniform thickness is obtained on the substrate 101. The graphene oxide powders are, for example, from a commercially available product.

In this step, by varying the concentration of the aqueous solution of the graphene oxide power, the thickness of the layer of graphene thus obtained is controlled; and this is convenient to operate. The obtained antistatic protective film not only can protect an electronic component from being scratched by a foreign object or damaged by rubbing, but also allows static electricity on the electronic component to be discharged in time, thus avoids the electronic component from being damaged by static electricity; therefore, the antistatic protective film provides the electronic component double protection.

In this embodiment, graphene oxide powders are uniformly coated on a conductive substrate, and then the graphene oxide powder is reduced by a reductant to a layer of graphene with a uniform thickness, thus an antistatic protective film is obtained; this procedure is not only easy to control the thickness of the grapheme layer, but also is simple and convenient to operate in the manufacturing process of the antistatic protective film.

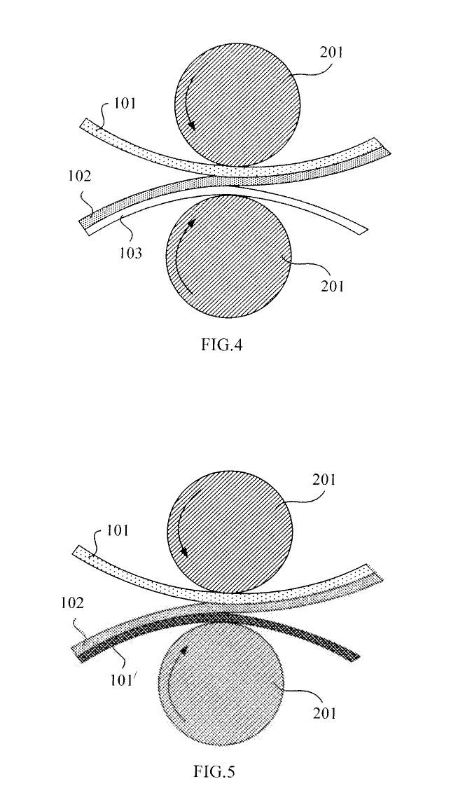

FIG. 3 is a flowchart illustrating a second embodiment of a preparation method of an antistatic protective film according to the present invention. As shown in FIG. 3, in this embodiment, a specific procedure of the method of preparing an antistatic protective film comprises steps as follows:

Step 301, placing a metal sheet in a chamber containing a carbonaceous gas.

In this step, the metal sheet may be a sheet of copper, rubidium, or chromium, etc; the carbonaceous gas may comprise at least one of the substances as follows: carbon monoxide, ethane, ethylene, ethanol, acetylene, propane, butadiene, cyclopentadiene, benzene and toluene; the carbonaceous gas is at a pressure in a range of 20-600 mTorr.

Step 302, pyrolyzing the carbonaceous gas at a preset temperature so that a layer of graphene is deposited on the metal sheet.

In this step, the preset temperature may be in a range of 600-1000° C.; the pyrolysis reaction time period of the carbonaceous gas is 10-40 minutes, and by varying the pyrolysis reaction time period of the carbonaceous gas, the thickness of the obtained graphene layer can be controlled; after the layer of graphene is obtained, the procedure proceeds to step 303.

Step 303, adhering the metal sheet and the graphene affixed together onto the substrate.

In this step, the metal sheet and the graphene affixed together, as obtained in step 302, are adhered to the substrate, in which the graphene and the substrate are in close contact.

For example, the metal sheet and the graphene affixed together may be adhered to the substrate in a roll-to-roll manner. The substrate may comprise any one of the substances as follows: polyethylene, polypropylene, polycarbonate, polyvinyl chloride, polyimide, epoxy resin, phenolic resin, and rubber; the substrate 102 may have a thickness in a range of 50-1000 nm, for example.

FIG. 4 is a schematic diagram illustrating a roll-to-roll adhesion manner in the embodiment. As shown in FIG. 4, the metal sheet 103 and the graphene layer 102 securely affixed together, as well as the substrate 101, are inserted between two press-rollers 201; after the metal sheet 103 and the graphene layer 102 securely affixed together are tightly adhered to the substrate 101, the procedure proceeds to step 304.

Step 304, removing the metal sheet by etching so that an antistatic protective film is obtained.

In this step, the metal sheet is removed by etching with an acidic solution such as hydrochloric acid, sulfuric acid, acetic acid, or the like, so that an antistatic protective film is obtained.

In another example, when the base-material in an antistatic protective film is the base-material with a relatively soft texture such as a polyethylene base-material, then in a roll-to-roll manner, the graphene layer in the antistatic protective film can be transferred from the base-material with a relatively soft texture onto the base-material with a relatively hard texture such as a PET base-material. FIG. 5 is a schematic diagram illustrating a roll-to-roll transfer-printing manner in the embodiment. As shown in FIG. 5, the antistatic protective film and a PET base-material 101 are inserted between two rotating press-rollers 201 from one side, so that at the other side of the press-rollers 201, the graphene layer 102 is separated from the polyethylene base-material 101′ and simultaneously adhered onto the PET base-material 101; thus, an antistatic protective film with a corresponding hardness is obtained.

In this embodiment, graphene is prepared through a chemical vapor deposition (CVD) method in a carbonaceous gas environment, then the graphene is tightly adhered to a base-material, and then the metal sheet is removed by etching with an acidic solution, thus an antistatic protective film is obtained; this procedure is not only easy to control the thickness of the grapheme layer, but also is simple and convenient to operate in the manufacturing process.

It should be understood that, the above embodiments are merely exemplary implementations used for explaining the principle of the present invention; however, the present invention is not limited thereto. For those ordinary skilled in the art, modifications and improvements can be made without departing from the spirit and essence of the present invention; accordingly, these modifications and improvements should also be included within the scope of the invention.

1. An antistatic protective film, comprise:
a layer of substrate, and
a layer of graphene;
wherein the substrate and the graphene layer are adhered together.

2. The antistatic protective film according to claim 1, wherein the graphene layer has a thickness in a range of 20-200 nm.

3. The antistatic protective film according to claim 1, wherein the material of the substrate comprises one of the substances as follows: polyethylene, polypropylene, polycarbonate, polyvinyl chloride, polyimide, epoxy resin, phenolic resin, polyethylene terephthalate (PET), and rubber.

4. The antistatic protective film according to claim 1, wherein the substrate has a thickness in a range of 50-1000 nm.

5. A display device, comprising the antistatic protective film in accordance with claim 1.

6. A method of preparing an antistatic protective film, comprising:
cleaning a substrate; and
preparing a layer of graphene on the substrate.

7. The method of preparing an antistatic protective film according to claim 6, wherein the step of preparing a layer of graphene on the substrate comprises:
placing a metal sheet is placed in a chamber containing a carbonaceous gas;
pyrolyzing the carbonaceous gas at a preset temperature, so that the layer of graphene is securely affixed on the metal sheet;
adhering the metal sheet and the securely affixed graphene to the substrate with the graphene being adhered on the substrate; and
removing the metal sheet by etching so that an antistatic protective film is obtained.

8. The method of preparing an antistatic protective film according to claim 7, wherein the preset temperature is in a range of 600-1000° C.;
the carbonaceous gas comprises a gas of at least one of the substances as follows: carbon monoxide, ethane, ethylene, ethanol, acetylene, propane, butadiene, cyclopentadiene, benzene and toluene.

9. The method of preparing an antistatic protective film according to claim 7, wherein the step of removing the metal sheet by etching, comprises:
removing the metal by etching with an acidic solution; and
the acidic solution comprises hydrochloric acid, sulfuric acid or acetic acid.

10. The method of preparing an antistatic protective film according to claim 6, wherein the step of preparing a layer of graphene on the substrate, comprises:
coating graphene oxide powders on a surface of the substrate; and
reducing the graphene oxide powders to graphene with a reductant;
the reductant comprises hydrazine, hydrazine hydrate, sodium borohydride or halogen acid.

11. The method of preparing an antistatic protective film according to claim 10, wherein the step of coating graphene oxide powder on a surface of the substrate, comprises:
dissolving the graphene oxide powders in water, the graphene oxide-aqueous solution having a concentration of 0.1˜10 mg/ml; and
subjecting the graphene oxide-aqueous solution to ultrasonic treatment.
